(19) United States
(12) Patent Application Publication
(10) Pub. No.: US 2014/0280603 A1
(43) Pub. Date: Sep. 18, 2014

(54) USER ATTENTION AND ACTIVITY IN CHAT SYSTEMS

(71) Applicant: Endemic Mobile Inc., Toronto (CA)

(72) Inventors: Joe RIDEOUT, Toronto (CA); Jonathan McGEE, Mississauga (CA)

(73) Assignee: Endemic Mobile Inc., Toronto (CA)

(21) Appl. No.: 14/210,751

(22) Filed: Mar. 14, 2014

Related U.S. Application Data
(60) Provisional application No. 61/783,479, filed on Mar. 14, 2013.

(51) Int. Cl. H04L 29/06

(52) U.S. Cl. CPC H04L 29/06034
USPC 709/205

(57) ABSTRACT

In a chat system user attention and activity can be reflected to other chat participants to increase communication effectiveness, immediacy, and quality. Further, efficient communication can be facilitated by a keyboard providing, in an intelligent manner, non-textual content for selection. User attention focus indicating the progress of a content consumption activity being performed using a display device can be determined and communicated to other chat participants. The content consumption activity can relate to content other than chat message text content. A graphical indication can be displayed to indicate an amount of chat message text input being input for a message that is not yet sent. Further, the indications of non-textual content for the keyboard can be populated according to content of a current chat or content of a chat history.

### CROSS REFERENCE TO RELATED APPLICATION

This application claims priority to U.S. provisional patent application 61/783,479, filed Mar. 14, 2013, the entire contents of which are incorporated herein by reference.

### FIELD

This disclosure relates to computers and, more specifically, to chat or instant messaging systems.

### BACKGROUND

Current chat systems have increasingly come to be built around, and associated with, other activities, such as shared online activities including concurrent game playing, video watching, and general consumption of information on the internet. Users will often be chatting with each other while concurrently watching a shared movie or consuming other content, editing a document, playing games, viewing pictures, or performing any other standard activities associated with the use of the internet, as well as performing one or more activities offline, or outside of chat and shared-content consumption systems. Though chatting via portable devices has become an integrated part of many people's lives, general purpose chat software are still lagging when it comes to integrating some of the features of the modern devices and software. More specifically, current general purpose chat software only provide limited ability for users to quickly share online, interactive, content, and, while a wealth of information is available in real time about where a user is focusing his attention while using a portable advice, little is done to seamlessly communicate this information when two or more device users are chatting with each other.

Current chatting systems rarely provide significant (or any) feedback to chat participants with respect to how other chat members are focusing their attention, when participating in a multi-person chat environment. Chat and chatroom software usually provide mechanisms indicating that one or more users have switched between a fixed set of states approximating attention (online, offline, or afk (away from keyboard), or variations thereof), usually also allowing user selected or edited identifiers for the states. Automated systems, mixed with manual input from users, are used for switching and reporting on changes between various user states as appropriate. Some in-game chat systems attempt to improve on this situation by providing additional, more complex, text-only and game-specific reporting on user actions and state changes (such as “user opened a chest”).

Given this background, in a fast paced chat, as well as in chat applications built around or including shared content consumption, it is often difficult for participants to track what the other participants are doing, and when. This is especially a problem for users chatting and concurrently consuming online content on mobile devices, where users may be “online” or actively inside the chatroom much more frequently, but for much shorter periods of time. A user may join a chat for a short burst of time, and not have a clear idea of whether there are other chat participants online, and whether their attention is focused on the chat, on some in-chat shared content, or elsewhere.

Video game specific, text-based, and systems for reporting user attention via status and in-game activities are highly specialized and complex. They require a period of training and adjustment before they can be used, and can often be overwhelming for use even by trained users, and do not easily port to other shared activities or content consumption. To date, none have been adapted for use in a general purpose chat application on mobile devices.

Online chat applications, especially those built for use on mobile devices, also do not currently provide support for quick, in-chat, sharing and concurrent consumption of content. Users may often be able to look for content elsewhere (by, for example, opening a separate video viewing application, photo taking application, or web browser), then copy-and-paste the content into the chat application. There is little effort made to support managing, and leveraging, of content already shared between users, and no tools or functionality are provided for concurrent, real-time, consumption or exploration of same content. For example, a user might take a photo with a photo application, then copy-and-paste it into a chat application, in a chat with several other users. There will then not be much feedback provided in terms of what the other users have done with the image the state of the art currently might, at most, provide a “message was delivered to” type feedback message within the chat application. Users will often be forced to spend some time waiting for feedback from other users/chat participants, indicating that they've consumed shared content, or to explicitly ask each other about whether and how the shared content was consumed, before being able to move on to more interesting communication about said content.

### BRIEF DESCRIPTION OF THE DRAWINGS

The drawings illustrate, by way of example only, embodiments of the present disclosure.

FIG. 1 is a diagram of chat system including multi-function client devices connected to a chat server via a network.

FIG. 2 is a diagram of the chat server.

FIG. 3 is a diagram of one of the multi-function devices.

FIGS. 4a-4d are diagrams of example graphical user interfaces for a meme keyboard.

FIGS. 5a-5b are diagrams of example graphical user interfaces for real-time reporting of user attention focus in a chat application.

FIG. 6a is a flowchart of a process for real-time chat input monitoring and indication.

FIG. 6b is a flowchart of a process for real-time chat content consumption monitoring and indication workflow.

FIG. 7 is a state diagram showing transitions between various user interface states.

### DETAILED DESCRIPTION

The present disclosure describes systems, servers, devices, processes, software, and user interfaces that enable chat users to better understand, in real-time, how other chat participants are focusing their attention, to more easily and more quickly discover and share interesting online content, and to concurrently and in real-time consume shared content.

The deficiencies identified in the background above are either eliminated or significantly reduced by the technology described herein.

The techniques described herein allow users to, in real-time, track the focus and attention of other users they are currently chatting with. Monitoring and tracking components are provided for real-time tracking of user activities when participating in a chatroom. Communication protocols are provided for real-time sharing information about tracked users. Further, specialized reporting tools are provided for real time reporting of actions of users within a chatroom to other users in the same room. Components to allow users to “join in” and participate in an ongoing shareable experience that other chat users are currently engaged in are also provided.

An intuitive interface component is provided. The interface component, which may termed a visual meme keyboard, is suitable for discovering interesting or relevant online content, and for quickly sharing of newly discovered content, and re-sharing of older content, with other chat participants. The online content sharing mechanism enables users to, concurrently and in real time, consume the same shared content, while continuing to chat via general purpose mobile devices.

Focus and attention reporting tool is provided and is capable of reporting of shared activity, which can reduce or minimize shared information (so as to not spam or overwhelm a user with irrelevant information), formatting of reporting in ways which are socially acceptable, and presenting activities in a manner which intuitively suggests whether, and how, a user might join and participate in an activity currently performed by one or more other users within the chatroom.

In some examples, the focus and attention reporting tool is configured for monitoring of when a user is typing text into the chatroom, and reporting, in real time, to other participants that the user is typing, and approximately how much text the user has typed.

In some examples, the focus and attention reporting tool is configured for monitoring of when a user is viewing an image or other item of shared content, and, optionally, where the user is focusing his/her attention (by, for example, zooming in). Reporting what the user is viewing is performed in real time to other participants via an inline chat message. An example of such a message is “John is viewing X”, where X is a visual indicator of John's attention, such as a scaled-down version of the image, showing exactly where, for example, John is zoomed in.

In some examples, the focus and attention reporting tool is configured for monitoring of when a user is viewing a video or other dynamic or active form of content, and how far along the content the user has progressed in his interaction with the content. Reporting to other users is performed in real time, via a message similar to “John is watching X”, where X is a visual indicator showing where John is currently focusing his attention (e.g., a real-time updated frame, showing time elapsed or remaining of a video being played).

In some examples, the focus and attention reporting tool is configured to provide “tap to join” functionality allowing one or more users to join in when watching a video or viewing an image, with separate indicators for each user to show how far each user has progressed in a video, whether (and where) the user is zoomed-in to an image, how far they have scrolled down a web page, or the like.

In some examples, the focus and attention reporting tool is configured to provide real-time feedback to users about which other chat participants have joined them in content consumption by, for example, providing a message of the form “Jane is now also watching X”.

FIG. 1 illustrates a chat system including a chat server 1000 and a plurality of chat client devices 1007, 1014. The chat system is an example, and the processes, user interfaces, and other techniques described herein can be applied to other chat systems. The chat system may also be known as an instant messaging system.

The chat server 1000 serves as a central controlling device for communication between the various client devices 1007, 1014. Amongst other services, the chat server 1000 includes a synchronization subsystem 1003, which is a service that provides representations of synchronized chatrooms 1001 and synchronized users 1002 that are consistent and regularly updated across all relevant hardware devices. The chat server 1000 also includes an archiving subsystem 1004, which provides a service for storing logs of changes to the various synchronized components of the system, and also acts as an arbiter in case, as may often happen with mobile devices, network connectivity and lag leads to suboptimal synchronization and synchronization conflicts across devices.

Synchronized user representations 1002 and synchronized chatrooms 1001 each provide programmable interfaces for manipulating data relevant to all of the current users of the chat system, as well as metadata, as required for the proper functioning of the server in its archiving, synchronization, and other functions. The specific implementation and details of the interfaces would be understood by those of skill in the art on reading this disclosure and are not intended to be limiting.

Data for user representations 1002 may include user status (such as online, afk, offline), current user attention focus information (such as typing text, viewing a video or image), user contact and friend information (such as a list of the user's friends on the chat system), and various other data.

Chatroom representations 1001 may include access to various data relevant to specific chatroom state and history, such as references to users who are participating in the chat, a log of the various chat messages that have been sent, and a log of status changes for users (such as when a user has joined or left the chatroom, when was the last time each user viewed the chatroom or performed other in-chat actions).

The chatroom representations 1001 and the user representations 1002 interact with the archiving subsystem 1004, which seamlessly stores all relevant actions and data.

The portable multi-function devices 1007, 1014 are electronic devices such as cellular or mobile phones, smart phones, tablet computers, and the like. Each device 1007, 1014 includes components and data for one or more synchronized chatrooms 1008, a synchronized local user representation 1009, one or more synchronized remote user representations 1010, and a synchronization subsystem 1011. The foregoing are hardware and programmatic implementations configured to interact with the respective server-side counterparts 1001, 1002, 1003. Specifically, the synchronization subsystem 1011 on each device 1007, 1014 is in communication with the synchronization subsystem 1003 of the server 1000 to synchronize chatrooms 1001, 1008 and user representations 1002, 1009, 1010.

Each device 1007, 1014 includes a local monitoring module 1013 configured to capture user status change to the local user 1009 and actions by the local user within the various chatrooms 1008. The local monitoring module 1013 is configured to report such changes and actions to the chat server 1000, so that such information is propagated to other devices 1007, 1014. The monitoring module 1013 provides interfaces to the various input and monitoring functionalities available on the device 1007, 1014.

Each device 1007, 1014 includes a reporting module 1012 configured to manipulate various user interface components, as well as other output and feedback components of the portable device 1007, 1014, such as phone vibration, sound output, and the like. Actions by users on other devices, and resulting changes, are represented by the remote user representations 1010, which provide functionality and interfaces for updating the various reporting modules 1012 [The word “module” may need to be changed].

The monitoring module 1013 and reporting module 1012 are connected to both the local and remote synchronized user representations 1009, 1010, as well as the synchronized chatrooms 1008, and are configured to appropriately update the various user interface components described below, as outlined in the included processes by, for example, updating the screen to display message such as “Jane is typing a message” when the remote user representation 1010 for Jane indicates that she is typing a message on a her device 1007, 1014, or by displaying a synchronized playback version of an online video when both the local user 1009 and a remote user 1010 are watching the same video at the same time.

The portable devices 1007, 1014 and the chat server 1000 are connected via a network of bidirectional communication channels 1005, such as may be provided by one or more of WiFi, Ethernet, Bluetooth, cellular and other network connections, that form part of or communicate via the Internet 1006 or other large network.

FIG. 2 shows the chat server 1000.

The chat server 1000 includes programmatic and hardware components to serve as an Internet-connected, hosted computer device. Such components can include memory 2001 that stores an operating system 2002 providing a software interface to the various hardware components of the server 1000, one or more network communications interfaces 2003 that provide abstractions to the various network connectivity devices (such as a network adaptor 2034), an I/O module 2004 providing a software interface to an I/O subsystem 2035, and a storage management module 2005 that provides a software interface to one or more external storage interfaces 2036. The chat server 1000 may further include other components, such as status monitoring tools 2006, to function as a well-behaved host connected to the Internet.

Implementations of the chat server 1000 may vary in functionality and may provide fewer or more components than discussed herein, and may provide these components in different forms than the processes and user interface components described. The disclosed details of the example chat server 1000 are not meant to be limiting.

Hardware components for the chat server 1000 include the memory 2001, which may be solid state, random access, programmable or any other kind of computer memory storage system, and a memory controller 2037, which provides memory control, abstractions, access and other functions. The chat server 1000 further includes one or more processors 2039, which run and execute the applications and other instructions stored in memory 2001, and a peripherals interface 2038 providing communication and manipulation functions to and from the various peripherals, the controllers, and the processors. All of the above components communicate with each other via a bus system 2028.

Peripheral devices may include one or more network adaptors 2034 or external communication devices for connecting to the network 1006, and one or more external storage interfaces 2036 and external storage devices 2026, providing abstractions for storing, manipulating, and retrieving large amounts of data. Further peripheral devices include a power system 2030 providing power grid connectivity, and various other external ports 2031 for providing connectivity and interfaces for other supporting systems and devices.

The I/O subsystem 2035 provides an interface and abstraction for manipulating various I/O devices such as a display, controlled by a display controller 2032, providing a visual and graphical interface to the various functions of the server 1000, and one or more input device controllers 2033, providing input functionality through various input devices, such as a mouse and keyboard.

The memory 2001 can further store applications 2007 including a virtualization program 2008, a database 2009, an anti-virus program 2010, a security program 2011, a web server 2012, and a chat service application 2013.

The chat service application 2013 can include a user administration module 2014, a logging module 2015, an image processing module 2016, a video processing module 2017, the synchronized user representations 1002, the synchronized chatrooms 1001, a connectivity module 2020, a message processing module 2021, the synchronization subsystem 1003, a configuration module 2023, a URL processing module 2024, and a statistics gathering module 2025.

FIG. 3 shows components of the chat client devices 1007, 1014.

Each of the devices 1007, 1014 includes memory 3001 that may include a memory storage device, such as flash memory, high-speed random-access memory, or the like, for storing various applications, processor instructions, and other services that run on and provide functionality to the device 1007, 1014. The memory 3001 is controlled and accessed through a memory controller 3045.

Each of the devices 1007, 1014 further includes one or more processors 3046 for executing programs, applications, various other instructions. The processor 3046 is configured to access and manipulate additional services and other hardware components within the portable multifunction device 1007, 1014 via a peripherals interface 3047, which provides communication, manipulation and other control functions.

Each of the devices 1007, 1014 may further include other components, such as a power system 3036 that provides access to power sources, such as an attached battery, or a connection to a power grid. External ports 3037 can be provided for connectivity and communication interfaces and services. A bus system 3028 is provided for communication of the components described above.

Each of the devices 1007, 1014 may further include RF circuitry 3032, and/or other network communication devices, configured to provide wireless or other bidirectional network access to the multifunction device 1007, 1014.

Each of the devices 1007, 1014 may further include audio circuitry 3033 connected to audio input and output devices, such as one or more speakers 3030, one or more microphones 3031, and the like. An example audio output port may be used with headphones, Bluetooth devices, or other wireless audio devices.

Each of the devices 1007, 1014 may further include an I/O subsystem 3038 configured to monitor user input and provide output and feedback to the user. The I/O subsystem 3038 may include a display controller 3039, an optical sensor controller 3040, and other input controllers 3041 configured to interface with and control, respectively, a touch sensitive display 3042, one or more optical sensors 3043, and one or more additional input devices 3044.

The touch sensitive display 3042 can be configured to provide graphical output for the user and may integrate or interact with one or more proximity sensors 3034 to determine whether and how the user is touching the screen.

The optical sensor 3043 can be any kind of such sensor, such as one configured to monitor ambient light conditions or one implementing fully functioning optical cameras and other photo or video capture devices.

The additional input devices 3044 can include devices such as Bluetooth connected keyboards and mice.

Additionally, each device 1007, 1014 may include a variety of monitoring sensors configured to monitor and detect a wide range of user activity. Such sensors may include, for example, a proximity sensor 3034 configured to monitor and report on user proximity to the device 1007, 1014, such as whether the device is being held next to the user's head.

Each device 1007, 1014 may further include an operating system 3002 for providing various low-level interfaces for control and communication for the various device components, a network communication module 3003 for providing an abstract interface for monitoring and communicating with other devices over a network connection as provided by the RF circuitry 3032 or other network communication component or interface, and a touch interface module 3004 configured to provide an interface and event system for monitoring, interpreting, and reporting on user interaction with touch sensitive I/O devices.

Each device 1007, 1014 may further include a graphical output module 3005 for providing low-level interfaces, CPU instructions, and other interaction functionality that enables manipulation of graphical output devices, such as the touch sensitive display 3042

Each device 1007, 1014 may further include a text input module 3006 configured to provide a low-level abstract interface for interpreting user text input commands that may be detected from I/O devices, such as a graphical keyboard representation (virtual keyboard) output at the touch sensitive display 3042, or other keyboard devices, such as Bluetooth or otherwise connected external keyboards

Each device 1007, 1014 may further include a GPS module 3008 that can be coupled to the RF circuitry 3032 and other network connectivity devices, such as a dedicated GPS component, to provide updated sets of coordinates and other global positioning information.

Each device 1007, 1014 may further include additional modules and interfaces indicated at 3007 for providing software level abstractions to additional input devices, sensors, and other peripherals connected to the device.

Each device 1007, 1014 may further include a dedicated sandbox environment for storing and executing applications 3009, providing hardware interfaces, independent resources, secure execution environments and other services to various software applications as may be installed by the device user. It is taken as understood that the specific applications and their implementation described below are examples and meant to provide context, and not meant to restrict the applicability of the processes and related UI components described within this disclosure.

Within the application sandbox environment 3009 many various types of both system and third-party applications may be installed and in a running state at any point in time. A contacts management application 3010 may provide a user interface and related functionality for the device user to be able to store and manipulate various contact information for users of other device (such as other phones or tablets) and/or software (for example social platforms such as Facebook and Twitter). One or more telephone applications 3011 may be provide telephone functionality using the Speaker 3030 and microphone 3031 or other available hardware and devices to communicate with other devices via the RF circuitry 3032 or other network connectivity services and components of the device. One or more SMS applications 3013 provide functionality and UI for the sending and receiving of SMS messages to provide communication with other devices via the various network connectivity components and services available on the device 1007, 1014. Other applications 3012 may also be present to provide other functionality and UI to the user.

Each device 1007, 1014 further includes a chat application 3014 configured to allow for communication with other devices via the chat system of FIG. 1, and provide the functionality UI described herein. The chat application 3014 described is a particular implementation and is not to be taken as limiting.

The chat application 3014 can include a contacts module 3015 configured to provide an in-application user interface for manipulating, adding, editing, and removing in-app contacts, as well as for importing contacts from external sources, such as an external contacts application 3010, or other applications running on the system, or services available on the Internet at large, such as those provided by Facebook and Twitter.

The chat application 3014 can further include a messaging module 3016 for providing an in-application user interface and functionality for sending, receiving, and displaying messages, both to in-application users, and also through externally provided services such as the SMS application 3013, and other applications that may be on the system, as well as services available on the internet at large, such as those provided by Facebook and Twitter.

The chat application 3014 can further include an image display module 3017 for providing an in-application user interface and functionality for displaying and manipulating images (for example, allowing for image resize, edit, zoom, and crop). The image display module 3017 may also be configured to capture user action events, as relevant to image manipulation, and provide a software interface for other modules of the chat application 3014 to detect and interpret such actions.

The chat application 3014 can further include a video display module 3018 configured to provide an in-application user interface and functionality for displaying and manipulating videos, as well as monitoring user activities as relevant for real-time synchronization of video watching, and reporting of user activities to the device monitoring module 1013.

The chat application 3014 can further store the synchronized local user representation 1009, which can include an in-application representation of data and information available about the local user of the application including whether the user is logged in to the application, references to the chat rooms 1008 the user is participating in, a current user status within a chatroom, as well as information about where the users attention is currently focused (such as, for example, whether the user is currently watching a video, searching for an image to send, or typing in a text message). The synchronized local user representation 1009 is synchronized with other user representations on other devices (as shown in FIG. 1) via the synchronization subsystem 1011. The synchronized local user representation 1009 provides read/write access to many of its components, allowing the chat application to update the local user with changes to the user's status, for propagation to other chat participants, as shown in FIG. 1 and described herein.

The chat application 3014 can further store one or more synchronized chatroom representations 1008, which can include in-application representations of data and information locally available about a given chat room, including a list of chat participants, and references to synchronized remote user representations 1010 for each chat participant. Each synchronized chatroom representations 1008 maintains and, via the synchronization subsystem 1011, synchronizes various relevant chatroom information including a list of recent chat messages, references to external urls, and other relevant metadata.

The chat application 3014 can further store several synchronized remote user representations 1010, one for each participant in each chatroom 1008, including read-only information about users, including their online statuses, attention focus details (such as whether they are watching a video, looking at an image, or manipulating an image, and other relevant details about each activity) and other data and metadata about remote users.

The chat application 3014 can further store one or more device monitoring modules 1013 for intercepting and interpreting various data provided by the device either directly or through in-application modules (such as the messaging, image display, and video modules 3016, 3017, 3018. The device monitoring modules 1013 intercept events such as a user input event, exposed by the messaging module 3016, interprets the event by a process (for example, identifies whether the user has started typing a new message, which chatroom the user is typing in, etc) and, when appropriate, updates the relevant synchronized representations, such as by updating the synchronized local user representation 1009 by setting a “is user currently typing” flag to true.

The chat application 3014 can further include one or more message display modules 3022 having functionality and services to interpret messages and determine whether and how messages should be displayed to the user. This can be done by, for example, detecting that a message contains video data and embedding graphical display information from the video display module 3018 when the message is displayed.

The chat application 3014 can further include a synchronization subsystem 1011 for providing communication, storage, memory manipulation and other functionality to ensure that synchronized objects, such as the synchronized user and synchronized chatroom representations 1009, 1008, 1010 are synchronized, in real time, with their counterpart representations on the chat server 1000 and other chat client devices 1007, 1014. The synchronization subsystem 1011 provides a significant advantage to the end user, since it permits general purpose, implicit, and real-time interactions between users in a chatroom.

The chat application 3014 can further include a configuration module 3024 for providing general application configuration functionality, services, and UI for the user to manipulate display options, as well as to configure login and other preferences.

The chat application 3014 can further include a web browsing module 3025 that can include specially instrumented web browsing components and can provide activity monitoring to intercept user attention focus changes and report such to the device monitoring module 1013.

The chat application 3014 can further include a webpage display module 3026 for providing functionality for displaying webpage information within the chat application 3014.

FIGS. 4a-4d show graphical user interface components for displaying a meme keyboard in a chat application, on a portable device 1007, 1014. FIG. 4a represents a chat system interface with the visual meme keyboard partially open, as shown after a tap other input at the open visual meme keyboard button 4012 (FIG. 4d). FIG. 4c represents a chat system interface with both the visual meme keyboard 4017 and a regular keyboard 4018 open, as may occur if the user decides to start typing text into a search/message box 4014. FIG. 4b shows the visual meme keyboard 4017 fully expanded, after a user presses down on the search/message bar 4013 and drags the bar upwards. FIG. 4d represents a chat application with the visual meme keyboard closed, as occurs if the user is typing into the search/message box 4014, but has not opened the visual meme keyboard 4017 by pressing button 4012, or has closed the visual meme keyboard 4017 by pressing on a close button 4005.

FIGS. 5a and 5b represent graphical user interface components for a chat application with built-in user attention reporting capabilities. FIG. 5a displays user attention focus feedback for a user typing, specifically a typed length indicator bar 4010 and an attention indicator bar 4011. FIG. 5b displays user attention focus feedback when the user is focusing on an interactive item (such as, but not limited to, an image, video, or webpage) shown at 4010, 4011, and 4020.

A border 4000 or other non-display area surrounds a touch-sensitive graphical display area 4001. A “Back” or “Exit” button 4002 may be present in a chat application, providing the user with the ability to, by touching the screen on that area, leave the current chatroom.

One or more circular graphical user representations 4003 may be present within the chat application. Each graphical user representations 4003 is populated with a small scale image representing one current chat participant.

The content aggregator button 4004 is a graphical representation of a button leading to a content aggregator screen. When the user presses the surface near this button, the user is taken from the current chat to a screen aggregating all of the content shared in the chat so far.

The meme keyboard close button 4005 allows the user to, by pressing on the screen on or near this button, signal the system to remove the visual meme keyboard 4017 from the screen. The system responds as appropriate, by removing the visual meme keyboard 4017 and replacing the close button 4005 with the open button 4012.

One or more on-screen message boxes 4006 may be visible on-screen, as may be provided by the message display module 3022 when interpreting a message.

The username textbox 4007 provides an on-screen identification for the user who has sent the message within the message box 4006 containing username textbox 4007.

The shared content box 4008 graphically represents a video, image, or other content shared within the chat, which may be interacted with by the user, as provided by the video or image or webpage display modules 3017, 3018, 3026, or any other content display modules that may be implemented by the application.

The text message box 4009 is an on-screen representation of a text message that has been previously shared within the current chatroom.

The typed length indicator bar 4010 is an on-screen graphical indicator of the amount of text typed in by a user, updated in real-time in response to changes to the appropriate remote user representation 1010. The relative length of the bar indicates the length of the message typed. The bar 4010 adjusts dynamically as the user adds or removes text, growing or shrinking as appropriate, and the text-to-image-size ratio can be adjusted as appropriate in order to maintain the bar 4010 as single line.

The attention indicator bar 4011 includes a graphical, horizontal text box that is configured to function as a text indicator summarising where a particular user's attention is focused. The attention indicator bar 4011 reacts in real or near real-time to changes in a user's attention, as they are propagated via the relevant remote user representation 1010. The attention indicator bar 4011 can display message such as “User is typing” or “User is searching for something to send”.

The positioning of the attention indicator bar 4011 can be selected based on what the user is currently doing, so that other users in the chat can determine, at a quick glance, whether the user is generating content (e.g., typing a message) or consuming content (e.g., watching a video). This can improve the chat experience by revealing general information about the user's attention and focus, without cluttering the screen with irrelevant details or disturbing existing habits and expectations of privacy. This is illustrated by the different example positions of the attention indicator bar 4011 in FIG. 5a (“Jane is typing”) as compared to FIG. 5b (“Jane is watching a video”).

The meme keyboard open button 4012 is configured to receive user input to open up the visual meme keyboard 4017, and the system responds as appropriate by showing the keyboard, and replacing the open button 4012 with the close button 4005. The search/message bar 4013 is a container for the search/message box 4014. Dragging the search/message bar 4013 upwards when the meme keyboard 4017 is on screen, causes the meme keyboard 4017 to expand to a full-screen configuration. Likewise, when the search/message bar 4013 is dragged downwards, the expanded meme keyboard 4017 is returned to the reduced configuration. The search/message box 4014 is configured to open the standard keyboard 4018 when pressed, and to initiate searches or send messages when a “Send” button 4019 to the right of the box 4014 is pressed. Text typed on the standard keyboard 4018 is displayed within the search/message box 4014.

Left and right scroll buttons 4015, when pressed by the user, refresh the visual meme keyboard 4017 content with new content via a left or right animation graphic. The contents of the visual meme keyboard 4017 can be scrolled through sequentially by pressing the left or right scroll buttons 4015, and are kept in order within the sequence.

In-chat shareable content icons 4016 each include a reduced-size image representing an item of content that can be selected to be added into the chat as a shared content box 4008, when the respective icon 4016 is pressed. Each icon may represent one or more of text, an image, an animated image (e.g., gif), a video, a web page, and/or other interactive content that can be added to the chat in the user's name.

The in-chat shareable content icons 4016 of the visual meme keyboard 4017 include representations of images, text, video, animated images, and other online shareable content. The visual meme keyboard 4017 is populated via an intelligent context-aware algorithm, which can reference content of the current chat, as well as content and one or more chat histories of one or more chat participants.

The send button 4019 can be pressed to send the text content of the search/message box 4014 as a text message to all the other chat participants, while all the relevant application components are updated including the synchronized chatroom 1008 and the message display module 3022.

The attention indicator box 4020 is a rectangular box, containing a multi-purpose graphical representation for a given user's current attention focus. The attention indicator box 4020 may represent an image, as it is being modified in real time, or it may be a zoomed in or reduced size representation of a video, updated to reflect changes as it is viewed and played in real time. The attention indicator box 4020 provides functionality required for a given user to, when pressing on the area on or near 4020 on the screen, join in and, in a synchronized, concurrent manner, participate with other chat users in the consumption of the same content represented in the box 4020.

FIG. 6a is a process flowchart 5000, showing a process for real-time monitoring and reporting of user typing events. The process begins in step 5001 with a Portable Device 1007, 1014 detecting that a user is typing some text for entry, first by pressing on an appropriate search/message Box 4014, and then by entering text via the standard keyboard 4018 as shown on the touch sensitive display 3042 and as intercepted by the touch interface module 3004, or via a peripheral input device 3044, such as a Bluetooth keyboard.

The text input event is then, in step 5002, reported through an appropriate controller 3039, 3041, to a text input module 3006, and intercepted in the chat application by a device monitoring module 1013 in step 5003. The device monitoring module 1013 then performs a test 5004 to determine if a new text message was started with this text input event. At the same time, the monitoring module 1013 updates the search/message Box 4014 to show the user what he/she has been typing, in step 5006.

If a new message was started with this text event, the monitoring module 1013 signals the synchronized local user representation 1009 to change the user state and indicate that the user is now typing a message, in step 5005. Whether this is a new message or not, in step 5007 the counter showing the amount of text the user has typed in this message so far is appropriately incremented. In steps 5008, 5009, the various synchronization system components 1003, 1011 propagate changes from the local user representation across all other representations, on other devices, of the same user, first by propagating the change up to the chat server 1000, and then, through the synchronization system 1003 on the server 1000, to other remote synchronized representations of the user as may be found on portable devices for other chat participants 1007, 1014.

On the other devices 1007, 1014, the messaging module 3016 determines if the “User is typing” flag has changed state and is now set, in step 5010. If the state has changed, in step 5011, the messaging module 3016 signals the message display module 3022 to display the attention indicator bar 4011, with a summary of where the user's attention is currently focused, such as “John is typing” or “John is writing a message”. The typed length indicator bar 4010 is updated to reflect the current amount of typed text, in step 5012.

FIG. 6b is a process flowchart 5013 showing a process for general monitoring and reporting user attention focus in real time. The process begins in step 5014 with a portable device 1007, 1014 detecting that a user is interacting with an element of chat content, such as a video, image, web page, or similar. The user can start an interaction by, for example, pressing on a shared content box 4008 containing an image or video. Alternatively, the user may be interacting or consuming content in one of the content display modules 3017, 3018, 3026, and may change the focus of his/her attention by, for example, zooming in to an image or scanning through a video. The user input may initially be intercepted by any input module or device, including for example, the peripheral input device 3044, such as a Bluetooth mouse or touchpad.

The user input event is then, in step 5015, reported through an appropriate controller 3039, 3041 to a touch interface module 3004 or other input interface module, and is intercepted in the chat application by the device monitoring module 1013 in step 5016. The device monitoring module 1013 then performs a test 5018 to determine whether this particular user interaction signifies the beginning of a user's consumption of or interaction with an element of chat-embedded content. At the same time, in step 5017, the monitoring module 1013 updates the relevant content display module 3017, 3018, 3026 with details of the user interaction, so that the user may perceive the desired interaction such as, but not limited to, zooming in to a picture, or scanning through a video.

If the current input event signifies that the user is just starting to consume or interact with an element of content through the application, the monitoring module 1013 signals the synchronized local user representation 1009 to change the user state and indicate that an attention indicator box should be displayed, in step 5019.

A test is performed in step 5021, to determine whether the current user interaction event signifies the end of a user's consumption of or interaction with the element of chat-embedded content. If the current input event signifies that the user is stopping an existing interaction or content consumption session, the monitoring module 1013 signals the synchronized local user representation 1009 to change the user state and indicate that an attention indicator box should no longer displayed, in step 5024.

In step 5027, the status of a “Display Attention Indicator Box” flag is propagated by the synchronization subsystem 1011, 1003 to the synchronized user representation on the chat server, and the synchronized remote user representations in other chat clients.

The monitoring modules 1013 at the other chat clients then react in real time to the change in the synchronized remote user representations. In step 5029, the monitoring modules 1013 at the other chat clients first test determine whether the “Display Attention Indicator Box” flag indicates that an attention indicator box 4020 should be displayed or not, and in steps 5028 and 5031 either display or hide the attention indicator box 4020, based on this determination. If the attention indicator box 4020 has just been displayed, in step 5030 the client software updates the contents of the attention indicator bar 4011 associated with the displayed attention indicator box 4020, with a text summary of where the user's attention is currently focused. For example, the attention indicator bar 4011 can be controlled to display text reading “John is watching a video”, “John is looking at a picture”, “John is looking at a website” and/or “John is looking for something to send you”, where John is the name of the respective chat user.

If a user input event is related to content consumption and does not signify the start or end of a content consumption or interaction session, then the monitoring module 1013 at step 5023 tests to determine whether the event signifies an identifiable shift in the focus of the user's attention. If the event does not signify an identifiable shift in attention focus, the event is ignored in step 5027.

If the event does signify an identifiable shift in user attention focus such as, for example, if the user is zooming in to a picture, or scanning through a video, or scrolling down through a web page, then relevant details for the user interaction event are recorded by the monitoring module 1013 in the synchronized local user representation 1009, in step 5020.

In step 5022, the synchronization subsystem 1011, 1009, 1003 propagates changes made in step 5020 through to the server-side synchronized user representation 1002, as well as the other remote user representations 1010 at other chat clients. The attention indicator boxes on other chat clients react in real time to the changes in the remote user representation 1010 in step 5026, interpreting the shift in attention and providing a visual representation of such shift in attention within the attention indicator box 4020. For example, the attention indicator box 4020 may display indication of a scan backwards or forwards for a playing video, an indication of a zoom action for an image that is being displayed, an indication that a web page is being scrolled, or the like.

The process described in FIG. 6a reports a user's in-chat attention. The typed length indicator bar 4010 shows to chat participants in real time when a user is engaged in the chat and responding to a message, without indicating the content of the message being typed, so as to preserve privacy until the message is sent.

In combination, the real time updates to 4010, 4011, 4020 described as part of the processes in FIGS. 6a and 6b enable chat users to better communicate with each other by creating an improved feeling of shared context and shared experience, which is especially important given the casual, short, and transitory nature of user communication on mobile devices. Shared experiences are further improved by the attention indicator box 4020, with its interactivity and relatively small size (compared to the device screen display area 4001), displaying the focus of attention for other chat users. Significantly, chat users are able to learn, at a glance, much about what all other chat participants are doing and where their attention is focused. The current communication trend of short bursts of messaging from mobile devices is enhanced with a feeling of shared context and shared experiences, without any significant change in behaviour relative to use of other, older chat systems.

FIG. 7 outlines the process for determining when and how to display the visual meme keyboard 4017. The display area 4001 of the touch sensitive display 3042 of the multi-purpose portable device 1007, 1014 may at any time show the visual meme keyboard 4017 as part of a chat application according to one of at least five different states:

State 6001: A basic chat display, as exemplified in FIGS. 5a and 5b, in which the visual meme keyboard 4017 is hidden.

State 6002: Basic chat functionality with the reduced version of the visual meme keyboard 4017, as exemplified in FIG. 4a.

State 6003: The reduced version of the visual meme keyboard 4017, a standard keyboard representation 4018, as well as a reduced version of the basic chat interface, as exemplified in FIG. 4c.

State 6004: An expanded (e.g., full-screen) version of the virtual meme keyboard 4017, as well as the standard keyboard representation 4018, as exemplified in FIG. 4b.

State 6005: The basic chat interface and the standard keyboard representation 4018, as exemplified in FIG. 4c.

Various user inputs cause transitions between states 6001-6005.

State 6001 transitions to state 6002 when the meme keyboard open button 4012 is pressed, at 6103.

State 6001 transitions to state 6005 when the user presses or otherwise indicates the search/input box 4014, at 6104.

State 6002 transitions to state 6003 when the user presses or otherwise indicates the search/input box 4014, at 6105.

State 6002 transitions to state 6001 if the user presses the close button 4005, at 6101.

States 6002, 6003, 6004 transition to state 6001 when an item is selected from the visual meme keyboard 4017, at 6106, 6111, 6114, and the item is sent by pressing the send button 4019, at 6107.

State 6003 transitions to state 6001 if the user presses the send button 4019, at 6107, to send to another user a message.

State 6003 transitions to state 6005 if the user presses the close button 4005, at 6109.

State 6003 transitions to state 6004 if the user presses on, or otherwise indicates, the search/message bar 4013 and then slides his/her finger up, at 6110.

State 6004 transitions to state 6001 if the user presses the send button 4019, at 6107, thereby sending a message to the other users.

State 6004 transitions to state 6005 if the user presses the Close Button 4005, at 6112.

State 6005 transitions to state 6001 if the user presses the send button 4019 to send a message, at 6102.

State 6005 transitions to state 6003 if the user presses the meme keyboard open button 4012, at 6108.

Chat systems implementing the visual meme keyboard 4017, and the process described in FIG. 7, allow for a significantly improved chat experience for users. The increased vocabulary and range of communication tools allows for a much deeper range of expression, allowing for more fine grained expression of emotions and thoughts, and significantly mitigates some of the common problems in known chat systems.

The above disclosure is not limited to specific hardware, systems, protocols, and underlying technology used to support the running of chat clients and servers, as well as to other supporting “third party” software and hardware. It is to be understood that this disclosure is not meant to be restricted to the specific systems, methodologies, or protocols discussed herein, as these may vary in their implementation and makeup, while providing sufficiently similar functionality and services to the ones described herein in order to allow for the described technology to be implemented.

While the foregoing provides certain non-limiting example embodiments, it should be understood that combinations, subsets, and variations of the foregoing are contemplated. The monopoly sought is defined by the claims.

What is claimed is:

1. A method comprising:
providing a chat system for communication among a plurality of chat clients over a network;
determining an attention focus for a chat client of the chat clients, the attention focus indicating the progress of a content consumption activity being performed at the chat client, the content consumption activity relating to content other than chat message text content;
synchronizing the determined attention focus to other chat clients; and
updating displays of the other chat clients based on the synchronized attention focus of the chat client to indicate the content consumption activity.

2. The method of claim 1, wherein determining the attention focus comprises determining that the chat client is performing a zoom operation on an image.

3. The method of claim 2, wherein the content consumption activity is indicated at the other chat clients by displaying an indication of a zoomed region of the image.

4. The method of claim 1, wherein determining the attention focus comprises determining that the chat client is playing a video.

5. The method of claim 4, wherein the content consumption activity is indicated at the other chat clients by displaying an indication of the playback progress of the video.

6. The method of claim 4, wherein the content consumption activity is indicated at the other chat clients by displaying an indication of scanning forwards or backwards within the video.

7. The method of claim 1, wherein determining the attention focus comprises determining that the chat client is scrolling a web page.

8. The method of claim 7, wherein the content consumption activity is indicated at the other chat clients by displaying an indication of scroll position in the web page.

9. The method of claim 1, wherein the content consumption activity is indicated at the other chat clients by displaying text descriptive of the content consumption activity.

10. The method of claim 1, further comprising:
determining an amount of chat message text being input at the chat client, the chat message text being input associated with a chat message that is not yet sent;
synchronizing the amount of chat message text being input to the other chat clients; and
updating the displays of the other chat clients to display a graphical indication of the amount of chat message text being input.

11. The method of claim 10, wherein the graphical indication comprises a graphical bar configured to grow in length at the amount of chat message text being input increase and shrink in length as the amount of chat message text being input decreases.

12. The method of claim 1, further comprising displaying at the chat client a keyboard comprising a plurality of indications of non-textual content for selection to send to the other chat clients as shared content within a current chat, the plurality of indications of non-textual content being populated in the keyboard according to one or more of content of the current chat and content of a chat history of one or more of the chat clients.

13. A method comprising:
providing a chat system for communication among a plurality of chat clients over a network;
determining an amount of chat message text being input at a chat client of the chat clients, the chat message text being input associated with a chat message that is not yet sent;
synchronizing the amount of chat message text being input to the other chat clients; and
updating the displays of the other chat clients to display a graphical indication of the amount of chat message text being input.

14. The method of claim 13, wherein the graphical indication comprises a graphical bar configured to grow in length at the amount of chat message text being input increase and shrink in length as the amount of chat message text being input decreases.

15. The method of claim 13, further comprising displaying at the chat client a keyboard comprising a plurality of indications of non-textual content for selection to send to the other chat clients as shared content within a current chat, the plurality of indications of non-textual content being populated in the keyboard according to one or more of content of the current chat and content of a chat history of one or more of the chat clients.

16. A method comprising:
providing a chat system for communication among a plurality of chat clients over a network;
synchronizing content within a current chat among the chat clients; and
displaying at a chat client of the chat clients a keyboard comprising a plurality of indications of non-textual content for selection to send to the other chat clients as shared content within the current chat, the plurality of indications of non-textual content being populated in the keyboard according to one or more of content of the current chat and content of a chat history of one or more of the chat clients.

17. The method of claim 16, wherein plurality of indications of non-textual content comprises indications of images, videos, and web pages.

18. A portable electronic device comprising:
a display;
an input interface;
a network communication interface;
memory; and
a processor coupled to the display, input interface, network communication interface, and memory, the processor configured to:
determine an attention focus indicating the progress of a content consumption activity being performed using the display device, the content consumption activity relating to content other than chat message text content;
generate a graphical indication to the display, the graphical indication indicating an amount of chat message text input at the input interface for a chat message that is not yet sent via the network communication interface; and
generate a keyboard to the display, the keyboard comprising a plurality of indications of non-textual content for selection at the input interface, the plurality of indications of non-textual content being populated in the keyboard according to one or more of content of a current chat being conducted via the network communication interface and content of a chat history stored in the memory.
